(19) United States
(12) Patent Application Publication
(10) Pub. No.: US 2008/0065395 A1
(43) Pub. Date: Mar. 13, 2008

(54) Intelligent marketing system and method

(76) Inventor: Eric J. Ferguson, Phoenix, AZ (US)

Correspondence Address: TIMOTHY M. BARLOW, CMR 480 Box 0007, APO, AE, 09128, US

(21) Appl. No.: 11/510,089

(22) Filed: Aug. 25, 2006

(51) Int. Cl. G06Q 10/00

(52) U.S. Cl. 705/1

(57) ABSTRACT

An intelligent marketing system receives a customer list from a client and acquires a list of prospects for the client. One or more demographic attributes is appended to the list. A logistic regression is performed to calculate the probability of response from each prospect. The client selects one or more prospects to contact based on a scaled score. The system creates a contact file with the selected prospects and includes a unique response code for each desired prospect. The contact file is sent to a distribution center and each selected prospect is contacted. The unique response code is included with each contact. One or more prospects responds and is recognized due to the unique response code. The prospective customer selects a particular offer which is recorded in the contact file. The client accesses the web site and each prospective customer individually. Contacts and responses are correlated for each prospect.

### FIELD OF THE INVENTION

The present invention relates generally to the field of mailing systems and more particularly to an intelligent marketing system and method.

### BACKGROUND OF THE INVENTION

Traditional marketing and mailing systems are not very flexible. While it is possible to contact lots of people, it is very difficult, if impossible, to focus the contact information on particular types of people. For example, it may be impossible to selectively contact only those people who have a household income of at least $100,000, or who purchased home improvement services within the last 12 months, or who have a credit rating within a specified range. Yet many specialized services are simply not applicable to those who fall outside the specified ranges. Marketers are wasting their time by contacting those who fall outside the specified ranges.

In addition, focusing contacts upon a select group of people would result in more sales per contact, since many of the inapplicable people are not contacted in the first place.

Thus, what is desired is an intelligent marketing system that permits marketers to collect relevant demographic data and associate it with a large pool of customers to permit selective contact of members of the pool.

### SUMMARY OF INVENTION

An intelligent marketing system and method receives a customer list from a client and acquires a list of prospects for the client. If the client provides a written customer list, it will be converted into an electronic customer list. The prospect list may be a commercially-available list that includes various demographic data for those on the list. The system reviews the data to determine the mean of the attributes for each customer and compares this to non-customers to develop a profile for each.

In one embodiment, one or more demographic attributes are appended to the list of prospects. These demographic attributes include age, income, marital status, home owner status, home value, date purchased, zip code, area code and many others. The attributes can be automatically screened or reviewed for consistency for each customer. Inconsistencies can be deleted entirely, or alternatively, the system can retain the latest information while disregarding the oldest information. Alternatively, the file with inconsistencies can be flagged for review at a later time.

The system merges the customer list and the prospect list into a single file, and performs a logistic regression with that single file. In one embodiment, the system creates a model that calculates a probability of response from each prospect or customer in the single file. Next, the probability of response is scaled into a number range, such as from 1 to 10, with 1 being the lowest probability of response and 10 the highest. The output is reviewed for errors and the ability of the independent variables to predict the dependent, and the process is repeated to ensure validity and data cleanliness. The system then incorporates the probability of response information into the single file.

Next, the system uploads the single file into a web server, and provides access to the single file for a client. In one embodiment, the client accesses the single file via an Internet web site. Within the single file, the prospective customers are distinguished using the scores and attributes relevant to the contact selection. Finally, the client selects one or more desired prospects from the single file. In one embodiment, the client selects one or more prospects based upon the prospect's probability of response score or one or more demographic attributes.

In another embodiment, the system creates a contact file with the one or more selected prospects. This file is dedicated to only the selected prospects so it is typically a much smaller file to handle and process than the single file. A unique response code is included for each desired prospect with the contact file. This unique response code will be used later for identification of the desired prospect. The client can then design a communication, whether a mailing, email, or telemarketing script, for distribution to those on the contact file. The client can choose from an assortment of available mailpieces, channels and scripts from within the web server. Alternatively, the client can review contacts or communications to see what had been used in the past. In addition, the client can review one or more historical action tables (HAT). Each HAT contains the details of one or more campaigns, including the date a prospective customer was contacted, the number of times offered, the product offered, and the venue and times selected. This table will compound over time with each prospective customer. A customer will then have the ability to respond via the web and/or phone each time which will further add to this central table. The HAT gives the customer the ability to RSVP and see the exact program they are responding to.

In another embodiment, the contact file is sent to a distribution center. The distribution center can be a mail house, a telemarketer, or an Internet marketer. For a mail house, the client can direct that the mail file be sent to a mail house for printing and shipping. This can be done via FTP through a VPN. Pre-printed stocks of mail pieces can be used with laser lettering described by the mail file, to include name, address, product, offer, client, etc. Similar processes can be used with other channels to include phone, email, sms, and possibly multiple channels. Next, each selected prospect in the contact file is contacted, whether by mail, telephone or Internet. A copy of the contact file is preserved on the server for future use.

In a further embodiment, one or more prospective customers responds to the contact he received. The prospective customers can respond via Internet or telephone. The prospective customers are prompted to provide the unique response code from the contact received via mail, telephone or Internet. The system recognizes each prospective customer based upon their unique response code. Since the prospective customer is now identified, the system can now address the prospect by name. All interaction between a prospective customer and the system is recorded and filed with the rest of the information about the prospective customer based upon the unique response code. Next, the system enables the prospective customer to select a particular show or offer as described in the contact via mail, telephone or Internet. The system records the prospect's selection in the single file. The prospective customer can removed by the client or permitted to remove himself from the single customer file.

In another embodiment, the client accesses the web site where the single file and the contact file are stored on a web server. Further, the client can access each prospective customer individually and review the specific response information provided from each prospective customer.

In another embodiment, the system correlates the contacts and responses for each prospective customer. The prospective customer is associated with the HAT associated with the communication or offer described above. The system automatically determines which prospective customers signed up for a particular show or offer. When prospective customers participate in a show or respond to an offer, records are kept to identify each participant and the type and amount of response. The system can use the unique response code for the prospective customer, or his name or other information, to correlate such participation with the information for that prospective customer in the single file and the contact file. After the show occurs, the client can then go back into the web site to see all who RSVP'd or participated. The client can summarize the information into a report collectively or individually. The client has access to all prior interactions with the prospect and can enter new notes that are useful for current or future interactions.

In yet a further embodiment, as more information is entered about one or more prospective customers in the system, the system automatically accesses all prior interactions with each prospective customer and amends the information file for each prospective customer. If the information file for one or more prospective customers is amended, the system returns to step 108 and performs a logistic regression with the single file for those with new or amended information. As above, the system calculates the probability of response for each prospect or customer in the single file. These calculations may result in a new probability of response scaled score for some of the prospective customers. The system then incorporates the updated probability of response information into the single file.

In another embodiment, the system automatically correlates the contacts and responses to the various demographic attributes in the single file. In yet another embodiment, the system correlates the contacts and responses to their timing as well as the type of contact. The system will record the type of contacts or offers that receive responses. Of those that receive responses, the system will record the timing between the contact or offer and the response. The system correlates positive and negative responses to the amount of time between contacts or offers to a particular prospective customer. Ultimately, the system includes a large database of offer or contact information and the response to each offer or contact. The system then includes the timing between the contact or offer and a positive response, and the timing between positive responses from a particular prospective customer. All communications are aggregated to allow for continuous learning (e.g., responses increase 2× when mailing every 90 days vs. 60 days, or a particular communication was sent to a prospect in the past with no response; it may be a good idea to try a new communication.).

In addition, the various demographic data are correlated to this information. The sum total of this information provides the single file with trend information that can be used to plan subsequent targeted contacts or offers. Further enhancements to the system are centrally managed and will become transparent to the client with increasing results.

### BRIEF DESCRIPTION OF THE DRAWINGS

FIG. 1 is a flowchart of the steps in an intelligent marketing system, according to the resent invention;

FIGS. 2 and 3 depict the structure of an intelligent marketing system, in accordance with the present invention; and

FIGS. 4-11 show parts of a user interface system for an intelligent marketing system, in accordance with the present invention.

### DETAILED DESCRIPTION OF THE DRAWINGS

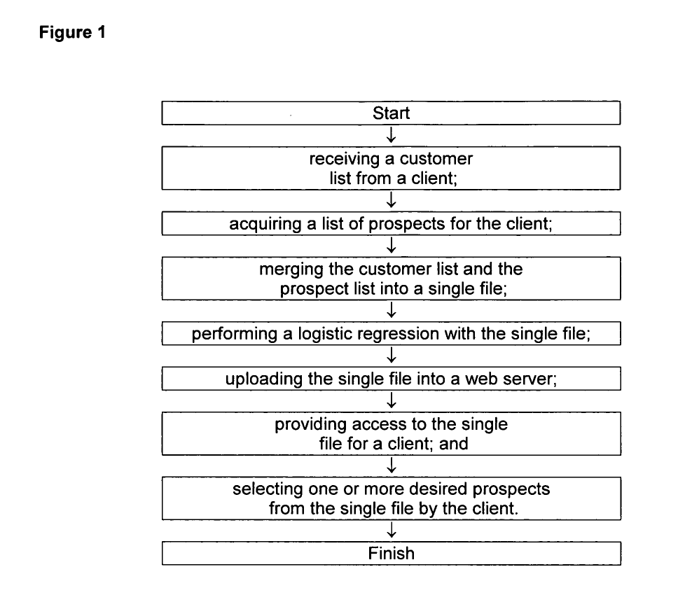

FIG. 1 shows a view of an intelligent marketing system that starts, step 100, by receiving a customer list from a client, step 102 and acquiring a list of prospects for the client, step 104. If the client provides a written customer list, it will be converted into an electronic customer list. The prospect list may be a commercially-available list that includes various demographic data for those on the list. The data is reviewed to determine the mean of the attributes for each customer and compared to non-customers to develop a profile for each. In one embodiment, one or more demographic attributes are appended to the list of prospects. These demographic attributes include age, income, marital status, home owner status, home value, date purchased, zip code, area code and many others. A more complete list is available on FIG. 12. The attributes can be automatically screened or reviewed for consistency for each customer. Inconsistencies can be deleted entirely, or alternatively, the system can retain the latest information while disregarding the oldest information.

Alternatively, the file with inconsistencies can be flagged for review at a later time. Next, step 106, the system merges the customer list and the prospect list into a single file, and performs a logistic regression with the single file, step 108. This step can be performed with a program such as SAS, listing the client within the procedure as the dependent variable or variable to be predicted.

In one embodiment, the system creates a model that calculates a probability of response from each prospect or customer in the single file. Next, the probability of response is scaled into a number range, such as from 1 to 10, with 1 being the lowest probability of response and 10 the highest. The output is reviewed for errors and the ability of the independent variables to predict the dependent, and the process is repeated to ensure validity and data cleanliness. The system then incorporates the probability of response information into the single file.

Next, step 110, the system uploads the single file into a web server, and provides access to the single file for a client, step 112. In one embodiment, the client accesses the single file via an Internet web site. Within the single file, the prospective customers are distinguished using the scores and attributes relevant to the contact selection. Finally, step 114, the client selects one or more desired prospects from the single file, ending the process, step 116. In one embodiment, the client selects one or more prospects based upon the prospect's probability of response score or one or more demographic attributes.

In another embodiment, the system creates a contact file with the one or more selected prospects. This file is dedicated to only the selected prospects so it is typically a much smaller file to handle and process than the single file. A unique response code is included for each desired prospect with the contact file. This unique response code will be used later for identification of the desired prospect. The client can then design a communication, whether a mailing, email, or telemarketing script, for distribution to those on the contact file. The client can choose from an assortment of available mailpieces, channels and scripts from within the web server. Alternatively, the client can review contacts or communications to see what had been used in the past. In addition, the client can review one or more historical action tables (HAT). Each HAT contains the details of one or more campaigns, including the date a prospective customer was contacted, the number of times offered, the product offered, and the venue and times selected. This table will compound over time with each prospective customer. A customer will then have the ability to respond via the web and/or phone each time which will further add to this central table. The HAT gives the customer the ability to RSVP and see the exact program they are responding to.

In another embodiment, the contact file is sent to a distribution center. The distribution center can be a mail house, a telemarketer, or an Internet marketer. For a mail house, the client can direct that the mail file be sent to a mail house for printing and shipping. This can be done via FTP through a VPN. Pre-printed stocks of mail pieces can be used with laser lettering described by the mail file, to include name, address, product, offer, client, etc. Similar processes can be used with other channels to include phone, email, sms, and possibly multiple channels. Next, each selected prospect in the contact file is contacted, whether by mail, telephone or Internet. A copy of the contact file is preserved on the server for future use.

In a further embodiment, one or more prospective customers responds to the contact he received. The prospective customers can respond via Internet or telephone. The prospective customers are prompted to provide the unique response code from the contact received via mail, telephone or Internet. The system recognizes each prospective customer based upon their unique response code. Since the prospective customer is now identified, the system can now address the prospect by name. All interaction between a prospective customer and the system is recorded and filed with the rest of the information about the prospective customer based upon the unique response code. Next, the system enables the prospective customer to select a particular show or offer as described in the contact via mail, telephone or Internet. The system records the prospect's selection in the single file. The prospective customer can removed by the client or permitted to remove himself from the single customer file.

In another embodiment, the client accesses the web site where the single file and the contact file are stored on a web server. Further, the client can access each prospective customer individually and review the specific response information provided from each prospective customer.

In another embodiment, the system correlates the contacts and responses for each prospective customer. The prospective customer is associated with the HAT associated with the communication or offer described above. The system automatically determines which prospective customers signed up for a particular show or offer. When prospective customers participate in a show or respond to an offer, records are kept to identify each participant and the type and amount of response. The system can use the unique response code for the prospective customer, or his name or other information, to correlate such participation with the information for that prospective customer in the single file and the contact file. After the show occurs, the client can then go back into the web site to see all who RSVP'd or participated. The client can summarize the information into a report collectively or individually. The client has access to all prior interactions with the prospect and can enter new notes that are useful for current or future interactions.

In yet a further embodiment, as more information is entered about one or more prospective customers in the system, the system automatically accesses all prior interactions with each prospective customer and amends the information file for each prospective customer. If the information file for one or more prospective customers is amended, the system returns to step 108 and performs a logistic regression with the single file for those with new or amended information. As above, the system calculates the probability of response for each prospect or customer in the single file. These calculations may result in a new probability of response scaled score for some of the prospective customers. The system then incorporates the updated probability of response information into the single file.

In another embodiment, the system automatically correlates the contacts and responses to the various demographic attributes in the single file. In yet another embodiment, the system correlates the contacts and responses to their timing as well as the type of contact. The system will record the type of contacts or offers that receive responses. Of those that receive responses, the system will record the timing between the contact or offer and the response. The system correlates positive and negative responses to the amount of time between contacts or offers to a particular prospective customer. Ultimately, the system includes a large database of offer or contact information and the response to each offer or contact. The system then includes the timing between the contact or offer and a positive response, and the timing between positive responses from a particular prospective customer. All communications are aggregated to allow for continuous learning (e.g., responses increase 2× when mailing every 90 days vs. 60 days, or a particular communication was sent to a prospect in the past with no response; it may be a good idea to try a new communication.).

In addition, the various demographic data are correlated to this information. The sum total of this information provides the single file with trend information that can be used to plan subsequent targeted contacts or offers. Further enhancements to the system are centrally managed and will become transparent to the client with increasing results.

### Structure of the Intelligent Marketing System

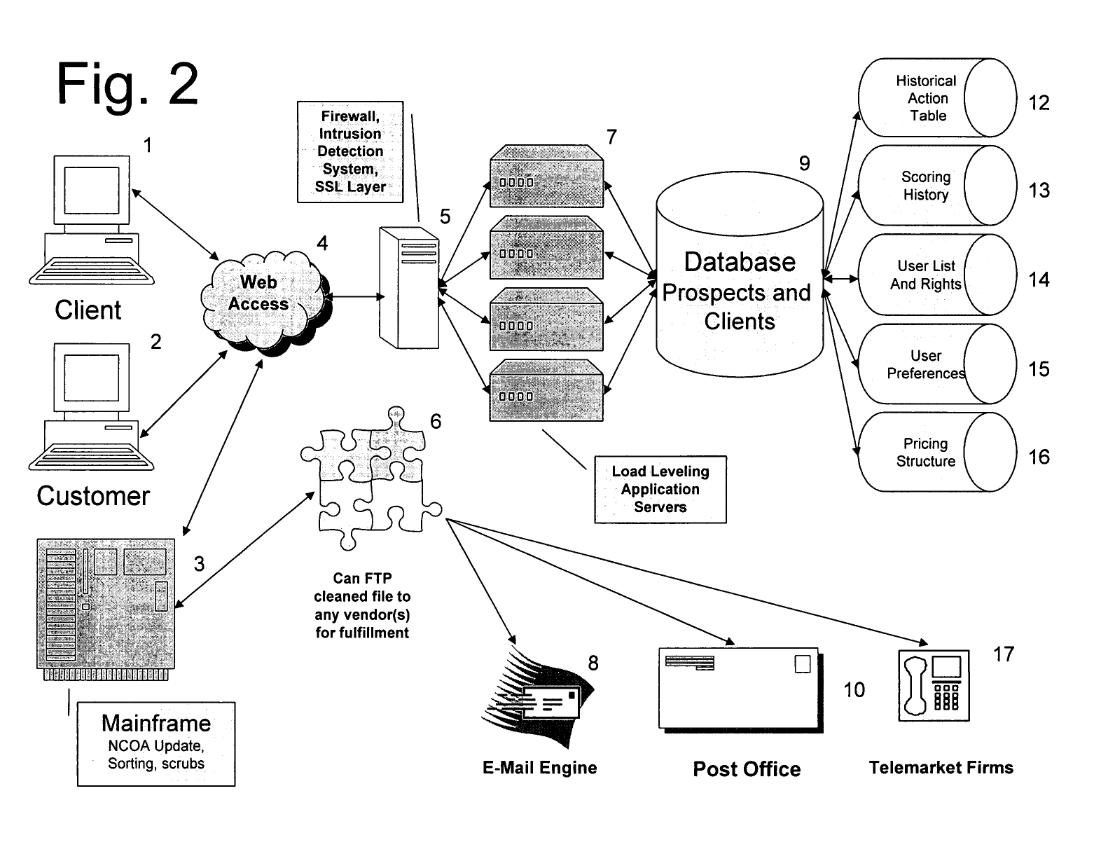

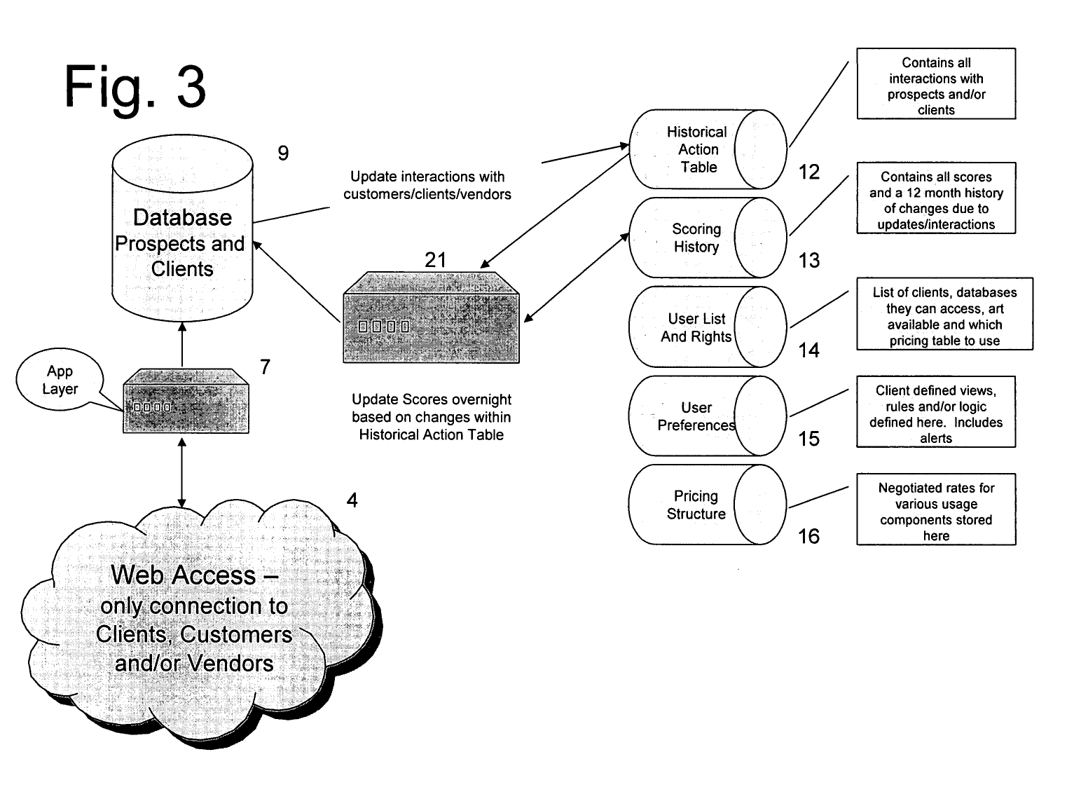

FIGS. 2 and 3 depict the structure of an intelligent marketing system, in accordance with the present invention.

A Client 1 is the person or entity who is contracting to engage in directed, intelligent marketing. The Client 1 is able to access the marketing system and direct all activities via Internet access 4. The Prospective Customer 2 is the person targeted by the marketing system. In one embodiment, the customer 2 has web access 4. A mainframe computer system 3 and/or a network computer system has access to external databases via the Internet 4, and is used to update mailing records and suppress bad addresses. The National Change of Address (NCOA) services can help to prevent NIXIES or misaddressed or illegibly addressed piece of mail which are undeliverable.

The system include some hardware 5 attached to the Internet 4, such as a server that houses the firewall, intrusion detection system, and or secure socket layer software. After preparation and scrubbing, a file can be FTP'd 6 from the mainframe 3 to a distributor or vendor for fulfillment of delivery. Upon receipt of the FTP'd file, various vendors can use email 8, postal services 10 or telemarketing firms 17 to communicate with prospective customers 2. An email delivery engine provides quick email distribution of the communication to the prospective customer 2. Files can also be FTP'd to a mail house for printing and eventual mailing through the post office 10. Files can also be FTP'd to telemarketing firms after script preparation. One or more load leveling application servers 7 can be used to speed up response times through the web 4.

A database 9 is in communication with the hardware 5 and contains all the prospective customers, actual customers and their attributes and demographics. A Historical Action Table (HAT) is part of the database 9 and contains all interactions with a prospect and/or customer. This includes the date and time of the interaction, the type of each interaction (mail, phone, email, etc) and the disposition or outcome of each interaction.

A scoring history table 13 is part of the database 9 and contains scores for each of the prospects. The scores may change over time. Historical scores and the subsequent changes may be kept here for reference and learning. A Users list and rights table 14 is part of the database 9 and contains the data necessary to control access to client lists, such as where a first client had access to list one, and where a second client has access to list two but not list one. A user preference table 15 is part of the database 9 and contains client-defined preferences, which include alerts, where and how to send them, client defined views, customer views, language choice, etc. A pricing structure table 16 is part of the database 9 and contains negotiated pricing to be charged to a client for each of the various services.

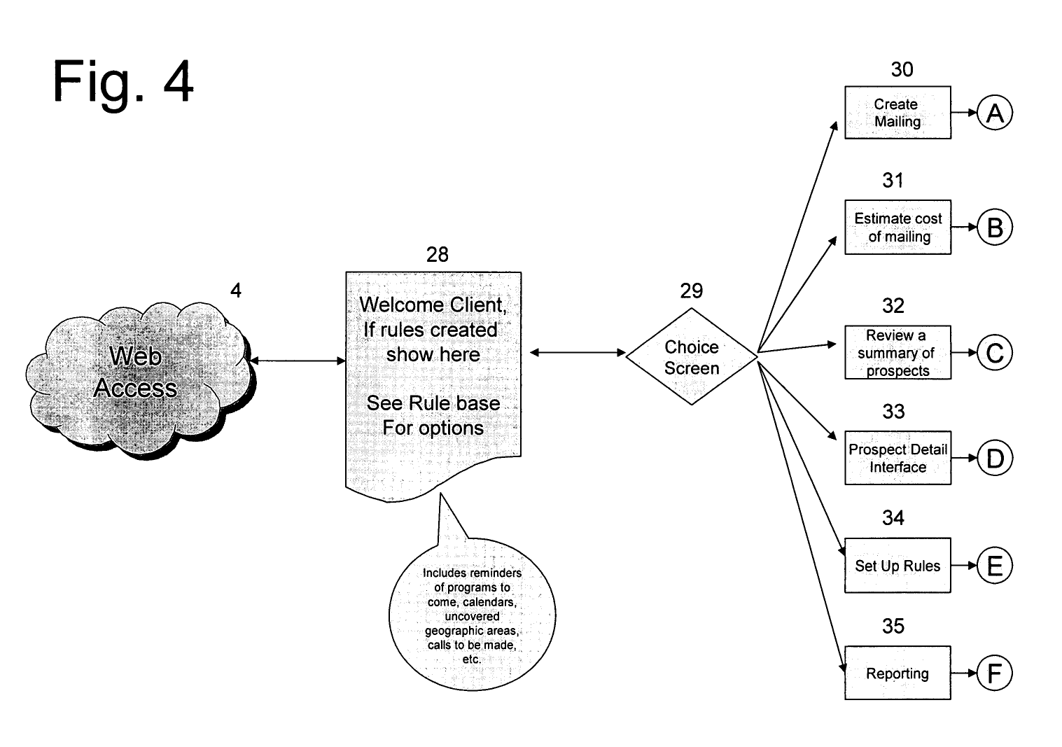

FIG. 3 shows a scoring CPU 21 that updates customer scores, using logic and/or algorithms provided, with new data from various sources and interactions. FIG. 4 shows part of a user interface system for an intelligent marketing system, in accordance with the present invention. The Internet 4 is used as a common portal for clients, customers and vendors. A welcome screen 28 that combines rules, user preferences and/or applicable alerts and views greets a client after authentication. A choice screen 29 presents applicable options to the authenticated client. One choice permits the user to create a marketing campaign 30. Another choice estimates the cost of a marketing campaign 31. Another choice permits a user to review a high level summary of prospects 32. Another choice permits a user to access the prospect detail interface 33. Another choice permits a user to set up and edit rules pertaining to his account 34. Another choice permits a user to review reports pertaining to an account 35.

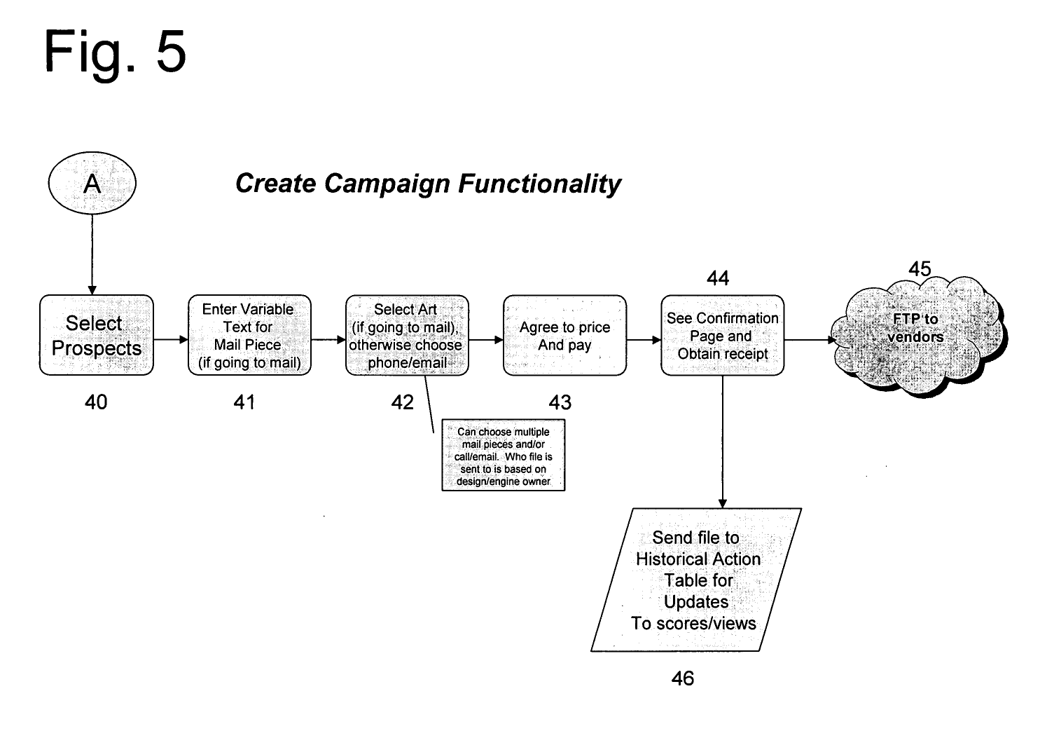

FIG. 5 shows part of a user interface system for an intelligent marketing system, in accordance with the present invention. FIG. 5 is a more detailed view of some of the options available to the user to create a mailing 30. Numerous options are available to the user, including selecting prospective clients 40 and the method by which they are targeted. Prospects may be targeted via the various scores or other defined means of targeting, including the various demographic attributes. Next, the user can enter variable text 41 to be displayed to a prospect on a marketing offer, such as a mailing or email. Next, the client can select art and a layout for the mail pieces or email. The client is thus able to direct marketing traffic to one or more media of his choosing. After the medium, vendor and lists are selected, a detailed price list 43 is created to confirm and pay for the prior selections. Once payment is secured, a confirmation page 44 is presented for the client to use as a receipt or reference for technical support. The path splits here. After confirmation, the table created by the campaign creation is written to the historical action table 46. In addition, based upon the medium selection, an FTP is created, encrypted and sent to the appropriate vendors 45.

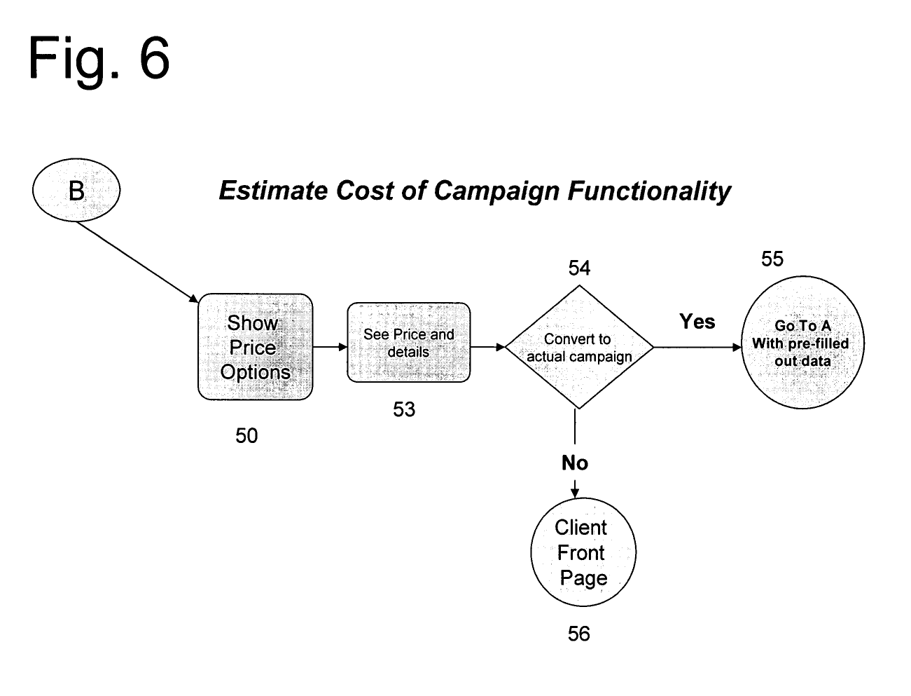

FIG. 6 shows part of a user interface system for an intelligent marketing system, in accordance with the present invention. FIG. 6 is a more detailed view of some of the options available to the user in estimating the cost of a mailing 31. A screen is presented to allow a client to display pricing options 50. This information is similar to 43, but the system does not ask for payment. Next, if a payment option is acceptable, a button is present to allow a client to convert this option into an actual campaign 54. Alternatively, the client can select the NO option, which sends the client back to the front page 56. If the client selects a payment option, the information is sent back to step 30 with the approved data already filled in.

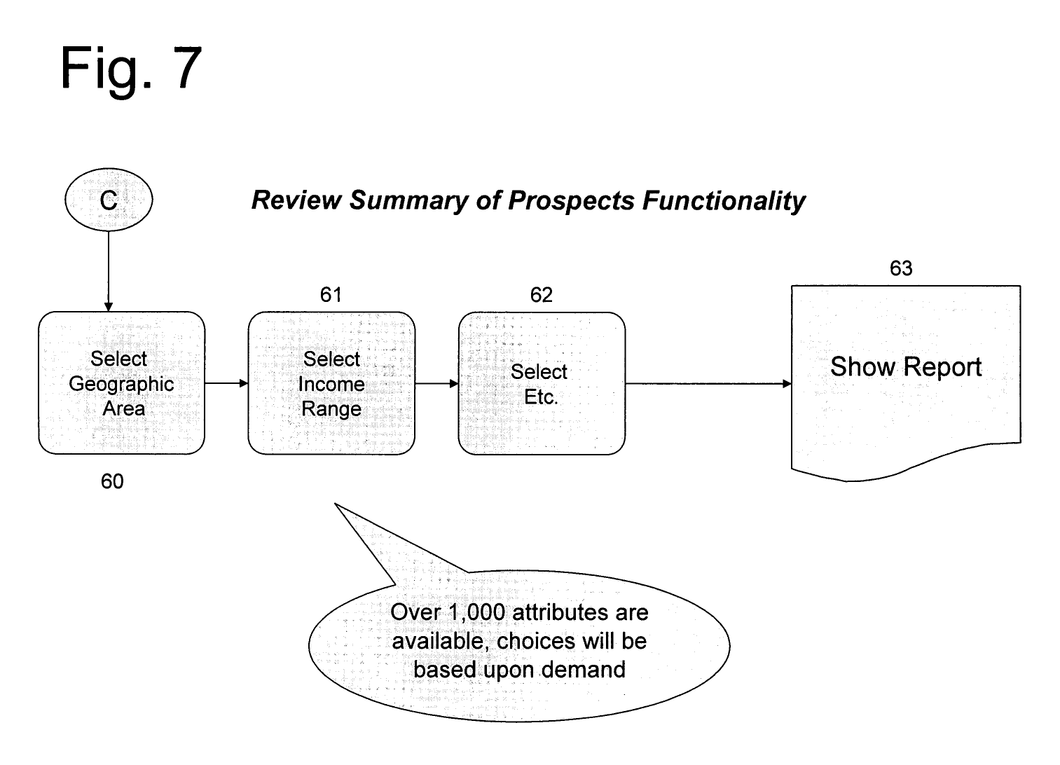

FIG. 7 shows part of a user interface system for an intelligent marketing system, in accordance with the present invention. FIG. 7 is a more detailed view of some of the options available to the user in reviewing a summary of the prospective customers 32. Here, a screen is presented that allows a client to see various stratifications of prospects including, but not limited to geography 60, score, age, income 61, and numerous other demographic attributes. At this stage, the attributes available to stratify prospective customers are presented. Over 1300 different attributes are available for purchase, based upon need. See variable list in FIG. 12. Once these attributes are selected 62, a report 63 is shown. The report screen 63 presents the outcome of the client's selection.

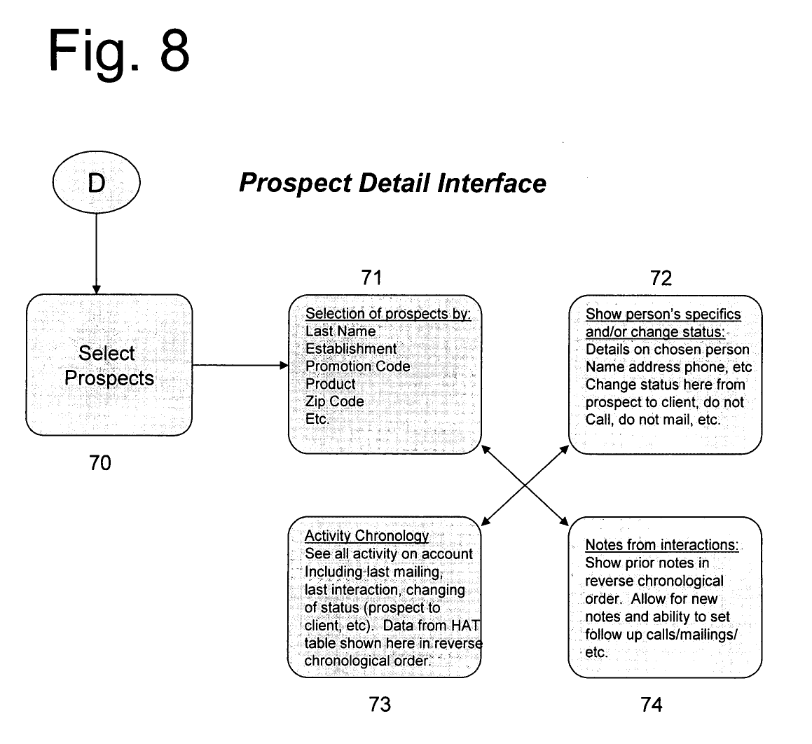

Next, FIG. 8, a four-box screen is displayed to show and/or edit interactions with prospects/customers. First, the client chooses that he would like to select prospects 70. Next, the upper left quadrant 71 contains the means for a client to select a prospect. These selections are used to populate the other three boxes 72, 73, 74 once chosen. Next, all applicable historical interactions are displayed 73 from the Historical Action Table. These interactions are specific to a client and don't overlap with other client's interactions unless agreed upon by all parties. A prospect's or client's status is displayed 72 along with the socio-demographic attributes. Here, the user can change the status of a customer to a non-customer, mail to do not mail, call to do not call, RSVP and other options. Notes from conversations past are shown here 74. The user has the ability to enter new notes from a current conversation here also. The client also has the ability to set appointments, and follow up calls and alerts.

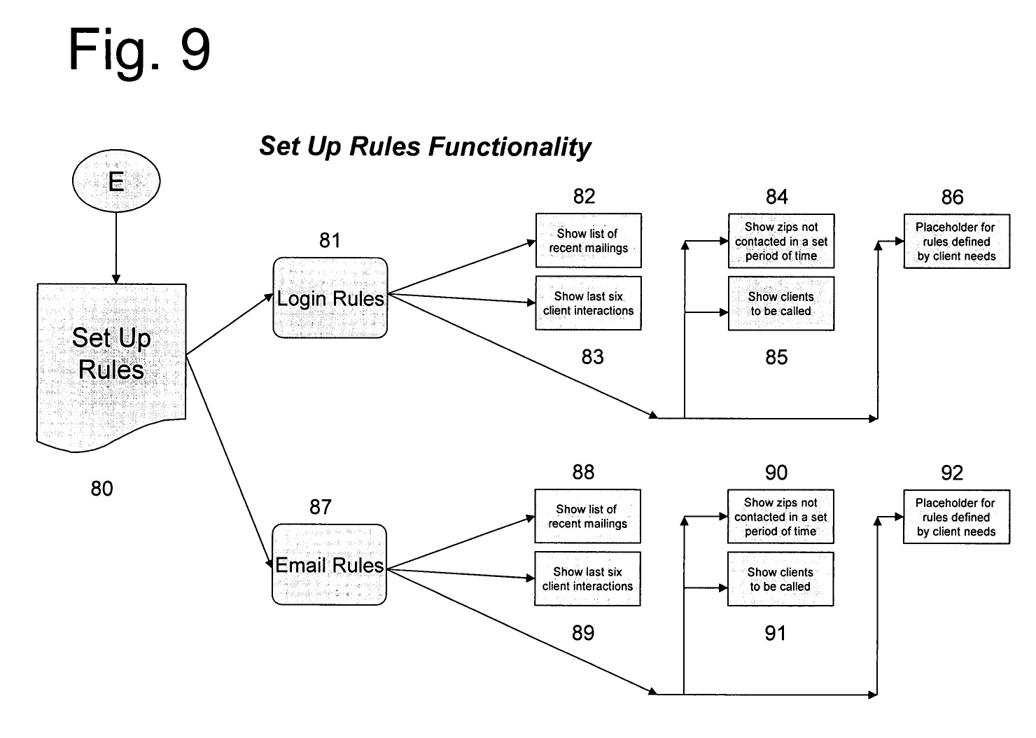

FIG. 9 shows part of a user interface system for an intelligent marketing system, in accordance with the present invention. FIG. 9 is a more detailed view of some of the options available to the user in setting up rules for operation 80. First, a screen is presented to enable the user to select which rules he would like to set up. Two of the options are the login rules 81 and the email rules 87. From the login rules selection 81, the client can perform many tasks. The client can see a recent list of mailing/marketing programs 82. In addition, the client can see the last six or more interactions between the client and their customers or prospects 83. The client can also see zip codes, area codes or other geographic identifiers that haven't been marketed in a predetermined period 84. The client can set up the time parameters here as well. Further, the client can view appointments or follow up phone calls that were previously scheduled 85. The system has great flexibility and permits a user to create his own rules for viewing nonstandard information or combinations 86.

From the email rules 87, the client can perform many tasks and provide himself with email alerts. The client can set up his account to send himself an email with the recent list of mailing/marketing programs on a periodic basis 88. In addition, the client can receive an email with the last six or more interactions between a client and his customers or prospects 89. The client can also set up email notifications and reminders to review zip codes, area codes or other geographic identifiers that haven't been marketed in a predetermined period 90. The client can set up the time parameters here as well. Further, the client can send himself an email reminder to review appointments or follow up phone calls that were previously scheduled 91. The system has great flexibility and permits a user to create his own rules for viewing nonstandard information or combinations 92.

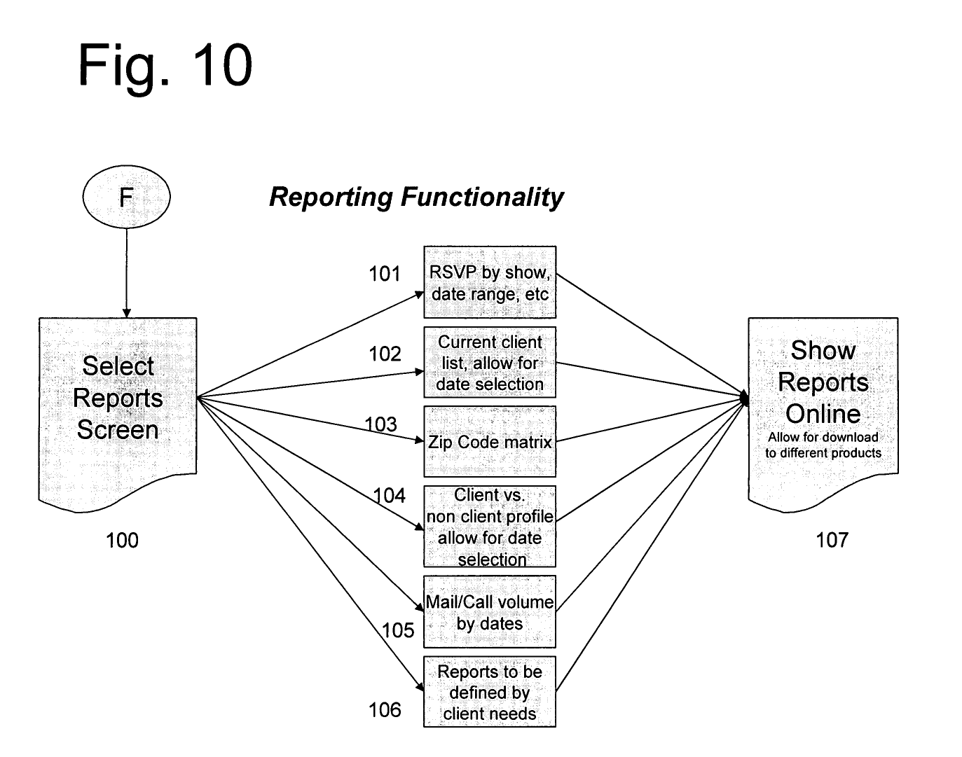

FIG. 10 shows part of a user interface system for an intelligent marketing system, in accordance with the present invention. FIG. 10 is a more detailed view of some of the options available to the user in creating and reviewing reports 100. The user is presented with a screen to permit him to select the reports option 100. Examples of the various reports available for viewing include a predefined report of RSVP's within a desired date entered range 101; a predefined report of current clients within a desired date entered range 102; a predefined report of a matrix of zip code and the last date of contact within a desired date entered range 103; a predefined report of client vs. non-client profile within a desired date entered range 104; a predefined report of mail/call volumes within a desired date entered range 105; and one or more place holders for future reports to be developed based upon clients needs 106. Each of the previously mentioned reports can be displayed on a user's computer via the Internet. The user also has the choice to download the reports and to select the desired format.

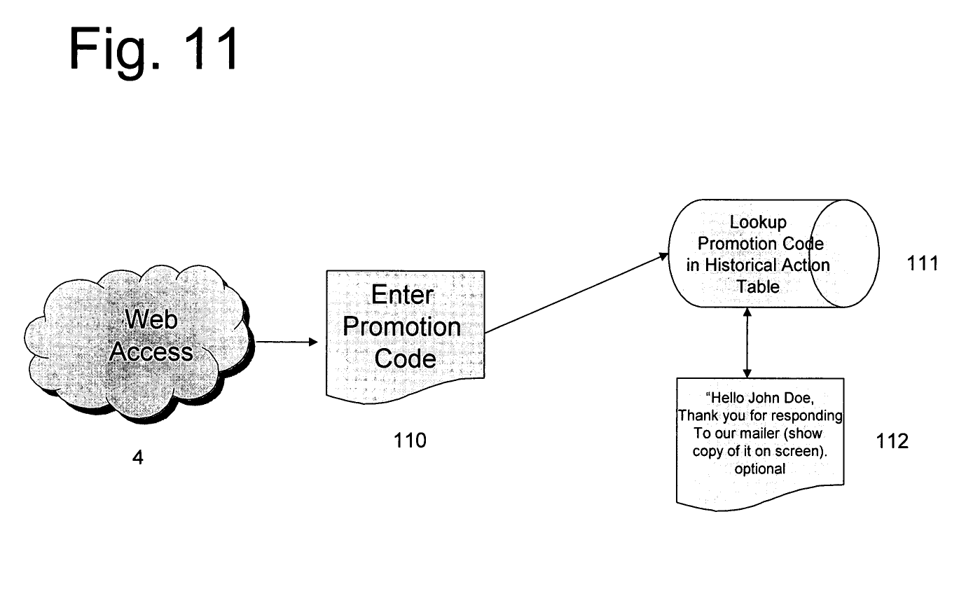

FIG. 11 shows part of an interface system for an intelligent marketing system, in accordance with the present invention. FIG. 11 is a view of the process encountered by a prospective customer. As above, the Internet 4 is used as a common portal for clients, customers and vendors. A prospect would enter a website provided by a marketing campaign such as EZRSVP.NET. The prospect would also have a promotion code associated with that campaign. Once the prospect has entered the website, a box will be shown that allows the prospect to enter their promotion code 110. After the promotion code is entered, the system will look up the promotion code located in the historical action table and find the particular offer made to the prospect 111. Next, the screen will greet the prospect with their name and the promotion offered 112. This screen also allows the prospect to RSVP with a button. Once the button is pushed, the prospect is thanked and the RSVP will be written into the Historical Action table where the client can see and know who will be in attendance.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An intelligent marketing system comprising the steps of:
(a) receiving a customer list from a client;
(b) acquiring a list of prospects for the client;
(c) merging the customer list and the prospect list into a single file;
(d) performing a logistic regression with the single file;
(e) uploading the single file into a web server;
(f) providing access to the single file for a client; and
(g) selecting one or more desired prospects from the single file by the client.

2. The intelligent marketing system of claim 1, further comprising the steps of:
(h) creating a contact file with the one or more selected prospects; and
(i) including a unique response code for each desired prospect with the contact file.

3. The intelligent marketing system of claim 2, further comprising the steps of:
(j) sending the contact file to a distribution center;
(j1) where the distribution center is a mail house.
(j1) where the distribution center is a telemarketer.
(j1) where the distribution center is an Internet marketer.
(k) contacting each selected prospect in the contact file;
(k1) including the unique response code with each mailing.
(i) contacting the selected prospect via mail.
(i) contacting the selected prospect via telephone.
(i) contacting the selected prospect via Internet.

4. The intelligent marketing system of claim 3, further comprising the steps of:
(l) responding to the contact by the one or more prospective customers;
(m) recognizing the prospective customer based upon the unique response code;
(n) enabling the prospective customer to select a particular show or offer;
(o) recording the prospect's selection in the contact file;

5. The intelligent marketing system of claim 4, further comprising the steps of:
(p) accessing the web site by the client;

6. The intelligent marketing system of claim 4, further comprising the steps of:
(q) accessing by the client each prospective customer individually;

7. The intelligent marketing system of claim 5, further comprising the steps of:
(r) correlating the contacts and responses for each prospect.

8. The intelligent marketing system of claim 1, where step (a) further comprises the step of:
(a1) converting a written customer list into an electronic customer list.

9. The intelligent marketing system of claim 1, where step (b) further comprises the step of:
(b1) appending one or more demographic attributes to the list of prospects selected using the stepwise logistic regression.

10. The intelligent marketing system of claim 1, where step (d) further comprises the step of:
(d1) creating a model that calculates a probability of response from each prospect or customer in the single file;
(d2) scaling the probability of response into a number range; and
(d3) incorporating the probability of response information into the single file.

11. The intelligent marketing system of claim 1, where step (f) further comprises the step of:
(f1) providing access to the single file via an Internet web site.

12. The intelligent marketing system of claim 1, where step (g) further comprises the step of:
(g1) selecting a prospect based upon the prospect's probability of response score.

13. The intelligent marketing system of claim 1, where step (g) further comprises the step of:
(g1) selecting a prospect based upon the one or more demographic attributes.

14. The intelligent marketing system of claim 2, where step (h) further comprises the step of:
(h1) preserving a copy of the contact file on the server for future use.

15. The intelligent marketing system of claim 3, where step (k) further comprises the step of:
(k1) including the unique response code with each mailing.

16. The intelligent marketing system of claim 4, where step (l) further comprises the step of:
(l1) responding via a website that is linked to the contact file, using the unique response code.

17. The intelligent marketing system of claim 5, where step (p) further comprises the step of:
(p1) determining which prospective customers signed up for the particular show or offer.

18. The intelligent marketing system of claim 5, where step (p) further comprises the step of:
(p1) determining which prospective customers participated in the particular show or offer.

19. The intelligent marketing system of claim 6, where step (q) further comprises the step of:
(q1) accessing all prior interactions with each prospective customer;
(q2) amending an information file for each prospective customer: and
(q3) if the information file is amended for at least one prospective customer, returning to step 10.

20. The intelligent marketing system of claim 7, where step (r) further comprises the step of:
(r1) correlating the contacts and responses to the various demographic attributes.

21. The intelligent marketing system of claim 7, where step (r) further comprises the step of:
(r1) correlating the contacts and responses to the timing and type of contact.
